(19) United States
(12) Patent Application Publication
(10) Pub. No.: US 2026/0320283 A1
(43) Pub. Date: Oct. 15, 2026

(54) WORK RECEPTION DEVICE, WORK RECEPTION METHOD, WORK REQUEST SYSTEM, AND WORK RECEPTION PROGRAM

(71) Applicant: Hitachi Systems, Ltd., Tokyo (JP)

(72) Inventor: Shinya IWASAKI, Tokyo (JP)

(73) Assignee: Hitachi Systems, Ltd., Tokyo (JP)

(21) Appl. No.: 18/849,361

(22) PCT Filed: Mar. 22, 2024
(86) PCT No.: PCT/JP2024/011327

§ 371 Date: Sep. 20, 2024

(30) Foreign Application Priority Data
Nov. 14, 2023 (JP) 2023-193564

(51) Int. Cl. G06F 40/166; G06Q 10/0631

(52) U.S. Cl. CPC G06F 40/166; G06Q 10/06315

(57) ABSTRACT

Provided is a technology for appropriately reflecting instructions for work changes received in natural language in the work list. A work reception device comprising a storage unit that stores work related to a room as a work list for each room number identifying the room, an instruction text creation unit that summarizes text to generate instruction text related to the work, a correction work generation unit that reads the instruction text to identify the changes in the work, and a correction application unit that updates the work list using the changes in the work.

### TECHNICAL FIELD

The present invention relates to a technology for a work reception device, work reception method, work request system, and work reception program. The present invention claims priority to Japanese Patent Application No. 2023-193564 filed on Nov. 14, 2023, the contents of which are incorporated herein by reference in designated states where incorporation of literature by reference is allowed.

### BACKGROUND ART

Cleaning work in inns (including various rooms, buildings, structures, signs, etc.) often involves changing the cleaning content of the target room according to the situation. Therefore, field managers who supervise cleaning work tend to frequently receive real-time changes in instructions from work requesters at inns via verbal communication or chat and instruct workers accordingly. However, field managers are often busy with on-site response, making it easy for mistakes such as forgetting or incomplete instructions to occur, resulting in issues with cleaning quality.

Patent Document 1 describes a business support system that includes a character information generation means that generates character information from speech in a meeting using speech recognition, a task generation means that obtains ToDos decided in the meeting from the generated character information and generates tasks according to the ToDos, and a task notification means that notifies relevant parties of the generated tasks.

### CITATION LIST

### Patent Literature

[PTL 1] Japanese Patent Application Publication No.2019-207612

### SUMMARY

### Technical Problem

The above system can generate tasks from the contents decided in a meeting and notify relevant parties. Therefore, it is effective in situations where tasks need to be generated and notified from scratch. However, its effectiveness is limited in cleaning work at inns, etc., where already set tasks need to be changed and executed.

The object of the present invention is to provide a technology that appropriately reflects instructions for work changes received in natural language in the work list, considering the above points.

### Solution to Problem

This application includes multiple means to solve at least part of the above problems. An example is as follows:

To solve the above problems, a work reception device according to one aspect of the present invention comprises a storage unit that stores work related to a room as a work list for each room number identifying the room, an instruction text generation unit that summarizes text to generate instruction text related to the work, a correction work generation unit that reads the instruction text to identify the changes in the work, and a correction application unit that updates the work list using the changes in the work.

In the above work reception device, the instruction text creation unit may have a summary generative AI that has learned to extract change instructions for the work content for each room included in the text.

In the above work reception device, the instruction text creation unit may have a summary generative AI that has learned to identify the boundaries of dialogues included in the text and extract change instructions for the work content.

In the above work reception device, the correction work generation unit may have a change content identification AI that has learned to ignore instruction texts if the contents indicated by the instruction text are already changed in the work list.

In the above work reception device, the text is a dialogue log made in a text chat or voice chat, and the correction application unit may output the changes in the work to the text chat or voice chat and update the work list upon receiving a positive response.

Furthermore, in the above work reception device, the correction work generation unit may read the instruction text for each room to identify the changes in the work.

In another aspect of the present invention, a work reception method using a work reception device comprises a storage unit that stores work related to a room as a work list for each room number identifying the room, and a processing unit that performs an instruction text generation step summarizing the text to generate instruction text related to the work, a correction work generation step that reads the instruction text to identify the changes in the work, and a correction application step that updates the work list using the changes in the work.

Another aspect of the present invention relates to a work request system using a work reception device comprising a storage unit that stores work related to a room as a work list for each room number identifying the room, and a processing unit that performs an instruction text generation step summarizing the text to generate instruction text related to the work, a correction work generation step that reads the instruction text to identify the changes in the work, and a correction application step that updates the work list using the changes in the work.

Another aspect of the present invention relates to a work reception program for causing an information processing device to perform work reception, the information processing device comprising a storage unit that stores work related to a room as a work list for each room number identifying the room, and a processing unit that performs an instruction text generation step summarizing the text to generate instruction text related to the work, a correction work generation step that reads the instruction text to identify the changes in the work, and a correction application step that updates the work list using the changes in the work.

### Effects of the Invention

According to the present invention, it is possible to provide technology that appropriately reflects instructions for work changes received in natural language in the work list.

Other problems, configurations, effects, etc., will be clarified through the following descriptions of embodiments.

### BRIEF DESCRIPTIONS OF THE DRAWINGS

FIG. 1 is a diagram showing an example of an overview of the work request system.

FIG. 2 is a diagram showing an example of an embodiment of the work request system.

FIG. 3 is a diagram showing an example of the default work list.

FIG. 4 is a diagram showing an example of the hardware configuration of the work reception device.

FIG. 5 is a diagram showing an example of the work request sequence.

FIG. 6 is a diagram showing an example of the work list update sequence.

FIG. 7 is a diagram showing an example of the work reception screen.

FIG. 8 is a diagram showing an example of the work list update screen.

FIG. 9 is a diagram showing an example of the system prompt.

### DESCRIPTION OF EMBODIMENT

Hereinafter, embodiments of the present invention will be described with reference to the drawings.

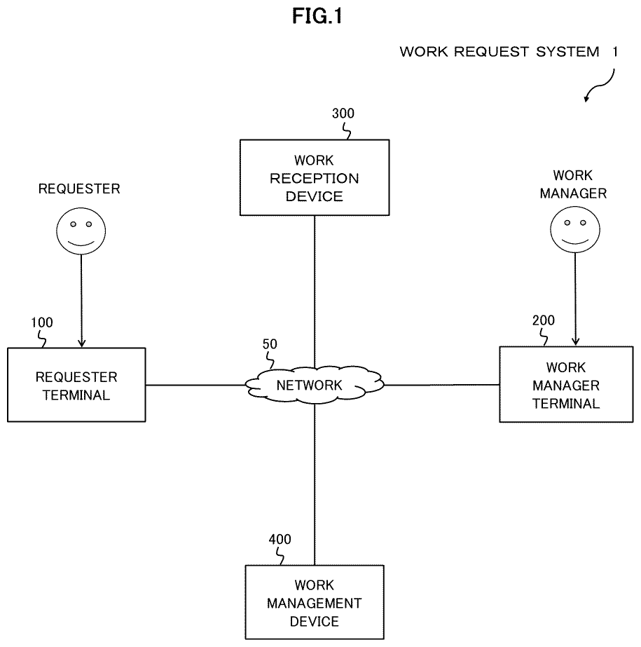

FIG. 1 is a diagram showing an example of an overview of the work request system. In this example, the work request system 1 is exemplified for cleaning work (e.g., hotels, office buildings). The requester and work manager refer to those who request cleaning work and those who act as the contact point for cleaning work requests, respectively. The facilities to be cleaned are not necessarily limited to hotels and office buildings and may include various rooms, buildings, structures, signs, etc.

In the work request system 1, the requester inputs work request information (e.g., changes in work content) in the chat room of the work reception device 300 via the requester terminal 100 through the network 50. The work manager communicates with the requester in the chat room of the work reception device 300 via the work manager terminal 200 through the network 50, and the work reception device 300 appropriately reflects the changes in work content in the work list based on the results. If the work management device 400 manages the work list, the work reception device 300 instructs the work management device 400 to reflect the changes in work content via the API (Application Programming Interface). Although the communication between the work manager and requester is done through a chat room, it is not limited to this and may be done in any space where the dialogue history can be tracked in chronological order, such as SNS (Social Networking Service), short messages, or video chats. Moreover, it is not limited to text-based chats and may include voice or video-based chats.

The requester terminal 100 and work manager terminal 200 are preferably portable information processing devices that can communicate with the work reception device 300 and work management device 400 via the network 50, such as smartphones, PDAs (Personal Digital Assistants), PCs (Personal Computers), or tablet devices. The functionalities of the requester terminal 100, work manager terminal 200, work reception device 300, and work management device 400 are realized by software running on an OS (Operating System).

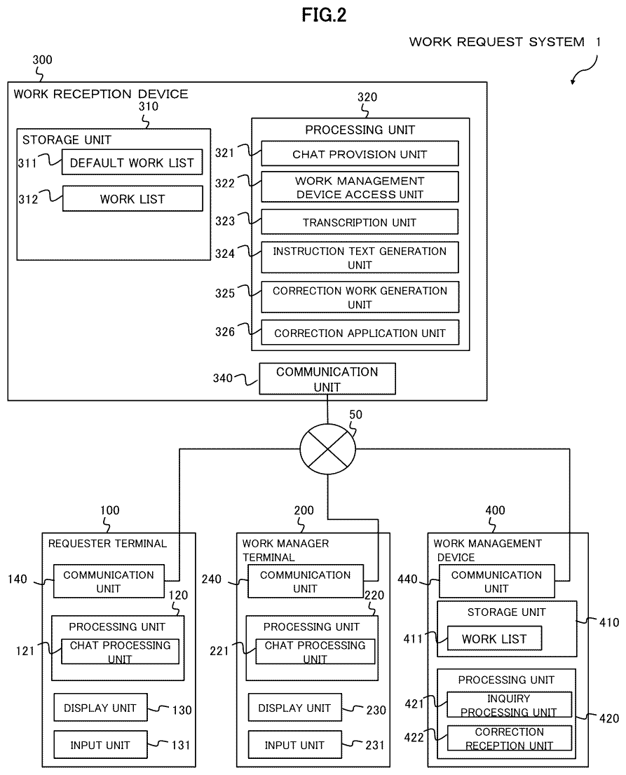

FIG. 2 is a diagram showing an example of an embodiment of the work request system. In the embodiment of the work request system 1, the requester terminal 100, the work reception device 300 connected to the requester terminal 100 via wired or wireless communication, the work manager terminal 200 connected to the work reception device 300 via the network 50, and the work management device 400 connected to the work reception device 300 via the network 50 are included.

The requester terminal 100 is basically an information processing device carried by the requester or lent by the company to which the manager belongs for business purposes. In this embodiment, the user of the requester terminal 100 is the requester. The work manager terminal 200 is basically an information processing device carried by the work manager or lent by the company to which the manager belongs for business purposes. In this embodiment, the direct user of the work manager terminal 200 is the work manager.

The network 50 is a network such as the Internet or an intranet. The network 50 is not limited to this and may also be a WAN (Wide Area Network), mobile phone network, or a composite network of these. Additionally, the network 50 may be a VPN (Virtual Private Network) on a wireless communication network such as a mobile phone communication network.

The work reception device 300 and work management device 400 are information processing devices such as so-called server devices. The connections between the work reception device 300, work management device 400, requester terminal 100, and work manager terminal 200 are via the network 50.

The requester terminal 100 includes at least a processing unit 120, a display unit 130, an input unit 131, and a communication unit 140. The processing unit 120 includes a chat processing unit 121 that realizes the so-called chat function. For example, the processing unit 120 logs into the chat room provided by the work reception device 300 to display the chat log and control browsing and input. The communication unit 140 communicates with other devices via wired or wireless communication. For example, the communication unit 140 communicates via various wired communication cables such as wired LAN (Local Area Network) cables or wireless LAN radio waves.

The work manager terminal 200 is basically the same as the requester terminal 100. The work manager terminal 200 includes at least a processing unit 220, a display unit 230, an input unit 231, and a communication unit 240. The processing unit 220 includes a chat processing unit 221 that realizes the so-called chat function. For example, the processing unit 220 logs into the chat room provided by the work reception device 300 to display the chat log (dialogue log) and control browsing and input. The communication unit 240 communicates with other devices via wired or wireless communication. For example, the communication unit 240 communicates via various wired communication cables such as wired LAN cables or wireless LAN radio waves.

The work reception device 300 includes a storage unit 310, a processing unit 320, and a communication unit 340. The storage unit 310 includes a default work list 311 and a work list 312.

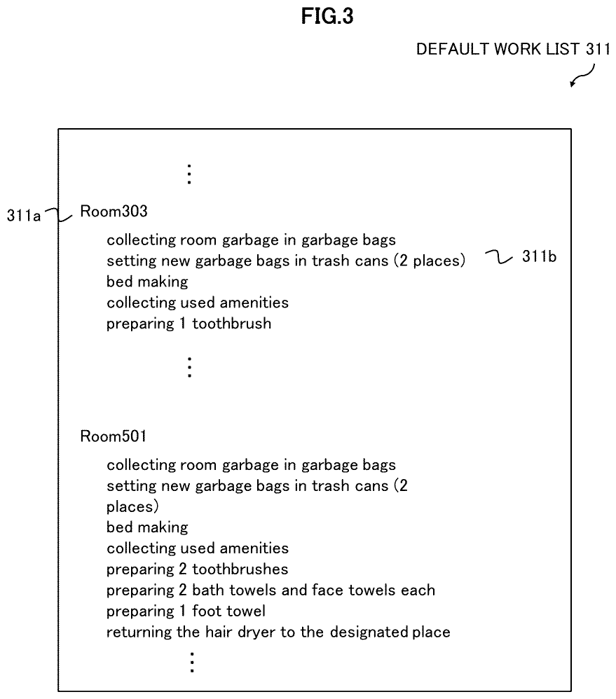

FIG. 3 is a diagram showing an example of the default work list. The default work list 311 stores the work related to each room identified by the room number 311a as work 311b. For example, in the default work list 311, for “Room 303,” works such as “collecting room garbage in garbage bags,” “setting new garbage bags in trash cans (2 places),” “bed making,” “collecting used amenities,” and “preparing 1 toothbrush” are stored in association with each other as the work 311b. For example, in the default work list 311, for “Room 501,” works such as “collecting room garbage in garbage bags,” “setting new garbage bags in trash cans (2 places),” “bed making,” “collecting used amenities,” “preparing 2 toothbrushes,” “preparing 2 bath towels and face towels each,” “preparing 1 foot towel,” and “returning the hair dryer to the designated place” are stored in association with each other as the work 311b.

Returning to the description of FIG. 2. The work list 312 is basically the same as the default work list 311. The work list 312 reflects the changes in work content in the default work list 311.

The processing unit 320 realizes application functions. The processing unit 320 includes a chat provision unit 321, a work management device access unit 322, a transcription unit 323, an instruction text generation unit 324, a correction work generation unit 325, and a correction application unit 326. The instruction text generation unit 324 and correction work generation unit 325 can use a generative AI that has acquired a language model (not shown). Specifically, the instruction text generation unit 324 and correction work generation unit 325 can use the output data generated by the generative AI by inputting input data into the generative AI. The generative AI is a pre-trained model that has been machine-learned or deep learning of a language model by neural network (NN) using language data in advance, such as GPT-4. The generative AI is not limited to neural networks (NN) and may use other known methods. Moreover, it is desirable to use a generative AI tuned by few-shot learning or fine-tuning.

The chat provision unit 321 provides functions for realizing chats between the requester terminal 100 and work manager terminal 200. For example, the chat provision unit 321 sets up chat rooms as needed or permanently, inviting the requester and work manager to realize text and voice chats.

The work management device access unit 322 inquires about information, receives provided information, and issues correction instructions to the work management device 400 via the network 50.

The transcription unit 323 converts speech information into text information (Speech To Text function) when the chat function provided by the chat provision unit 321 includes voice chats.

The instruction text generation unit 324 summarizes the chat text to generate instruction text related to the work. The instruction text generation unit 324 can use a summary generative AI that has learned to extract change instructions for the work content for each room included in the text. The instruction text generation unit 324 can also use a summary generative AI that has learned to identify the boundaries of dialogues included in the text and extract change instructions for the work content.

The correction work generation unit 325 reads the instruction text generated by the instruction text generation unit 324 for each room in the work list to identify the changes in the work. Specifically, the correction work generation unit 325 reads the instruction text generated by the instruction text generation unit 324 for each room, such as “Room 101,” to extract related work changes. When the correction work generation unit 325 completes extracting the changes for one room such as “Room 101”, the correction work generation unit 325 starts a new generative AI to extract the changes for the other room. In this way, although it depends on the specifications of the generation AI, it is possible to achieve the effect that changes in the work do not affect changes in the work in other rooms. The correction work generation unit 325 can use a change content specifying AI that has learned to ignore instruction texts if the contents indicated by the instruction text are already changed in the work list.

The correction application unit 326 updates the work list using the changes identified by the correction work generation unit 325. The correction application unit 326 outputs the changes to the chat room provided by the chat provision unit 321 via text or voice chat and updates the work list upon receiving a positive response (e.g., “yes,” “that's fine”). The correction application unit 326 instructs the work management device 400 to correct the information via the work management device access unit 322 when updating the work list.

The communication unit 340 communicates with other devices via wired or wireless communication. For example, the communication unit 340 communicates via various wired communication cables such as wired LAN cables or wireless LAN radio waves.

The work management device 400 is basically the same as the work reception device 300. The work management device 400 includes at least a storage unit 410, a processing unit 420, and a communication unit 440. The storage unit 410 includes a work list 411. The work list 411 stores work related to each work location (for example, a room to be cleaned) for each room number that identifies the work location. The work list 411 serves as the master information for the work and is used for the work progress management and viewing by workers under the command of the work manager. The work list 411 can be managed as a database, an object or data structure in memory, or a file in storage.

The processing unit 420 includes an inquiry processing unit 421 and a correction reception unit 422. The inquiry processing unit 421 receives inquiries about the work list from other devices, such as the work reception device 300, and sends the work list stored in the storage unit 410. The correction reception unit 422 receives the changes in work content and updates the work list 411.

The communication unit 440 communicates with other devices via wired or wireless communication. For example, the communication unit 440 communicates via various wired communication cables such as wired LAN cables or wireless LAN radio waves.

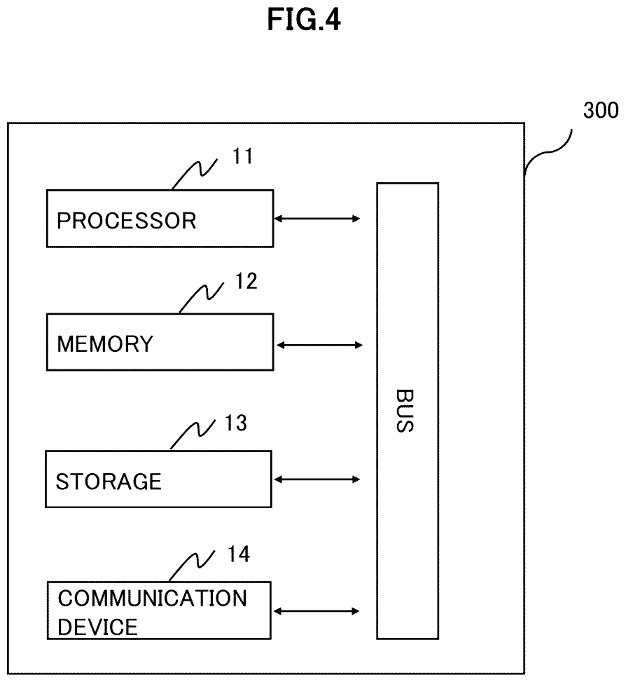

FIG. 4 is a diagram showing an example of the hardware configuration of the work reception device. The work reception device 300 includes a processor 11, memory 12, storage 13, and communication device 14, each connected by a bus. The power source can be a primary battery or a rechargeable secondary battery, which can be replaceable when exhausted or degraded.

The processor 11 is a computational device such as a CPU (Central Processing Unit) or GPU (Graphics Processing Unit) that executes processing according to programs stored in memory 12 or storage 13. In the work reception device 300, the processor 11, which operates according to programs read into memory 12 or storage 13, performs the processing. The processing unit 320, chat provision unit 321, work management device access unit 322, transcription unit 323, instruction text generation unit 324, correction work generation unit 325, and correction application unit 326 are realized by the processor 11 executing the programs.

The memory 12 is a storage device such as RAM (Random Access Memory) or flash memory that functions as a temporary read area for programs and data. The storage 13 is a writable and readable storage device. The function of the storage unit 310 is realized by the memory 12 or the storage 13. The function of the storage unit 310 may be realized by a storage device connected via the communication device 14.

The communication device 14 is an interface for connecting the work reception device 300 to external devices for communication. For example, the communication device 14 performs wireless communication using an antenna capable of utilizing specific radio waves (e.g., 5 GHz band, 2.4 GHz band) to establish a connection with the work management device 400 according to the Wi-Fi standard.

The processing of each component of the work reception device 300 may be executed on a single hardware or multiple hardware. The processing of each component of the work reception device 300 may be realized by a single program or multiple programs.

The hardware configuration of the requester terminal 100, work manager terminal 200, and work management device 400 is generally the same as that of the work reception device 300. However, the requester terminal 100 and work manager terminal 200 are often equipped with input/output devices such as a touch panel display and a microphone, similar to general smartphones.

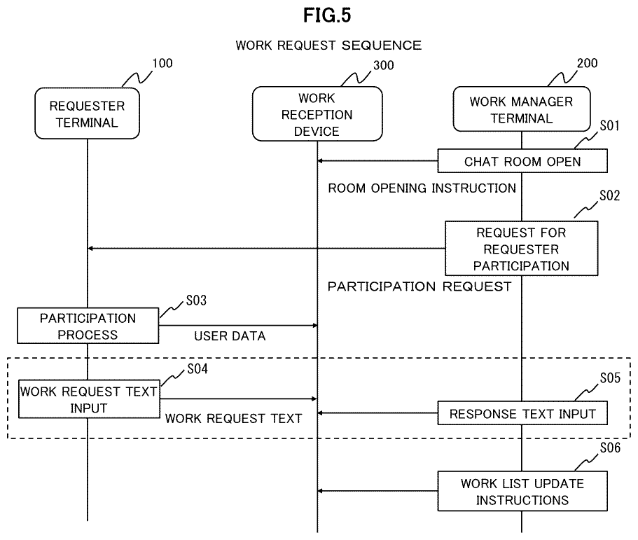

Next, the processing flow of the work request system 1 will be described. FIG. 5 is a diagram showing an example of the work request sequence of the work request system 1. The processing in this sequence diagram targets the sequence from opening the chat room under the direction of the work manager terminal 200, confirming the work change content in the chat, and starting the update of the work list under the direction of the work manager terminal 200. In addition, depending on the specifications of the chat room, there are those that are opened from time to time and those that are maintained semi-permanently once opened, but this sequence includes the situation where the first opening is performed. Therefore, the chat room may already be opened for the second and subsequent times, or it may be opened anew.

First, the work manager terminal 200 performs the chat room opening process with the work reception device 300 (Step S01). Specifically, the work manager terminal 200 sends a room opening instruction.

Then, the work manager terminal 200 sends a request to participate in the chat to the requester terminal 100 (Step S02).

Upon receiving the participation request, the requester terminal 100 sends user data to the work reception device 300 and participates in the chat (Step S03).

In the chat, the requester inputs the work request text via the chat processing unit 121 of the requester terminal 100 (Step S04). The input work request text is sent to the work reception device 300 as text information (work request text) on the chat.

The work manager, referring to the work request text posted on the chat log, inputs the response text to the work request text via the chat processing unit 221 of the work manager terminal 200 (Step S05).

After the dialogue has been conducted one or more times regarding the work request text, the work manager sends an instruction to update the work list to the work reception device 300 via the chat processing unit 221 of the work manager terminal 200 (Step S06).

The above is an example of the work request sequence. According to the work request sequence, work requests are made in a chat room where dialogue between the work manager and requester is possible, and after questions and answers regarding it, the dialogue log can be used to input the changes in work content.

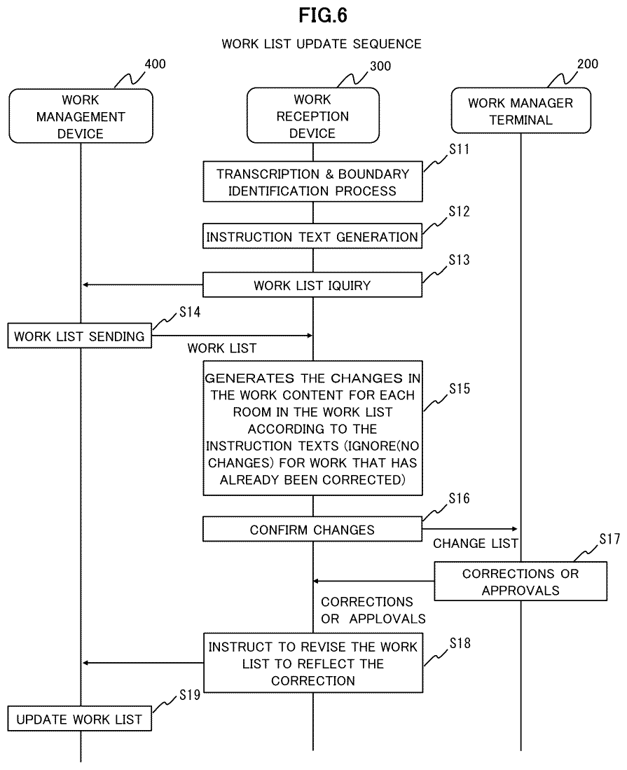

FIG. 6 is a diagram showing an example of the work list update sequence. The processing in this sequence diagram targets the sequence from the instruction to start updating the work list under the direction of the work manager terminal 200 to the completion of updating the work list.

First, the work reception device 300 performs transcription and boundary identification processing (Step S11). Specifically, the transcription unit 323 converts speech information into text information (Speech To Text function) if the chat function provided by the chat provision unit 321 includes voice chats. The transcription unit 323 identifies the boundaries of the dialogue in the text information from the text chat or the text information converted from the voice chat. If the transcription unit 323 detects a speech such as “understood” or “got it” in the text information or if a predetermined time (e.g., 5 minutes) has passed since the dialogue was interrupted, it may identify it as a boundary of the dialogue. The transcription unit 323 can also use a generative AI that has learned to extract such dialogue boundaries.

Then, the instruction text generation unit 324 generates instruction texts for each identified boundary of the dialogue text information (Step S12). Specifically, the instruction text generation unit 324 summarizes the chat text for each boundary to generate instruction texts related to the work. The instruction text generation unit 324 can use a summary generative AI that has learned to extract change instructions for the work content for each room included in the text. The instruction text generation unit 324 can also use a summary generative AI that has learned to identify the boundaries of dialogues included in the text and extract change instructions for the work content.

For example, if the input dialogue text information is “Hotel: Please make the towels in Room 301 two. Cleaning site manager: Room 301 is a double, so it is already two. Hotel: Sorry, it was Room 101. Cleaning site manager: Got it. Hotel: Please place an additional air purifier in Room 303. Cleaning site manager: Got it.”, the instruction text generation unit 324 identifies “Got it” by the site manager as the boundary, divides it into the first and second halves, and extracts change instructions for the work content. The instruction text generation unit 324 summarizes the first part to extract change instructions for the work content for each room and generates the instruction text “Make the towels in Room 101 two.” The instruction text generates unit 324 summarizes the second part to create the instruction text “Add an air purifier to Room 303.”

Then, the correction work generation unit 325 inquires about the work list to the work management device 400 (Step S13). Specifically, the correction work generation unit 325 inquires about the work list of the rooms with changes to the work from the work management device 400 via the work management device access unit 322.

The inquiry processing unit 421 of the work management device 400 sends the inquired work list to the work reception device 300 (Step S14). Specifically, the inquiry processing unit 421 reads the work list 411 stored in the storage unit 410, extracts the work list of the target rooms, and sends it.

Then, the correction work generation unit 325 generates the changes in the work content for each room in the work list according to the instruction texts (ignore(no changes) for work that has already been corrected) (Step S15). Specifically, the correction work generation unit 325 reads the instruction texts generated by the instruction text generation unit 324 for each room in the work list to identify the changes in the work. The correction work generation unit 325 can use a change content specifying AI that has learned to ignore instruction texts if the contents indicated by the instruction text are already changed in the work list (to eliminate duplicate work changes).

Then, the correction application unit 326 displays the changes to the work manager terminal 200 for confirmation (Step S16). Specifically, the changes are output to the chat room provided by the chat provision unit 321 via text or voice chat, and corrections or approvals are received.

The chat processing unit 221 of the work manager terminal 200 inputs the corrections or approvals via the chat (Step S17). Specifically, the chat processing unit 221 receives the input of corrections or approvals from the work manager and adds it to the chat speech in the work reception device 300.

Then, if there is a correction, the correction application unit 326 instructs the work list to be corrected by reflecting the change (step S18). Specifically, the correction application unit 326 reflects the corrections in the changes or, if there is an approval response, instructs the work management device 400 to correct the work list via the work management device access unit 322.

The correction reception unit 422 of the work management device 400 receives the changes in work content and updates the work list 411 with the changes (Step S19).

The above is an example of the work list update sequence. According to the work list update sequence, it is possible to update the work list managed by the work management device 400 by reflecting the content of the dialogue log.

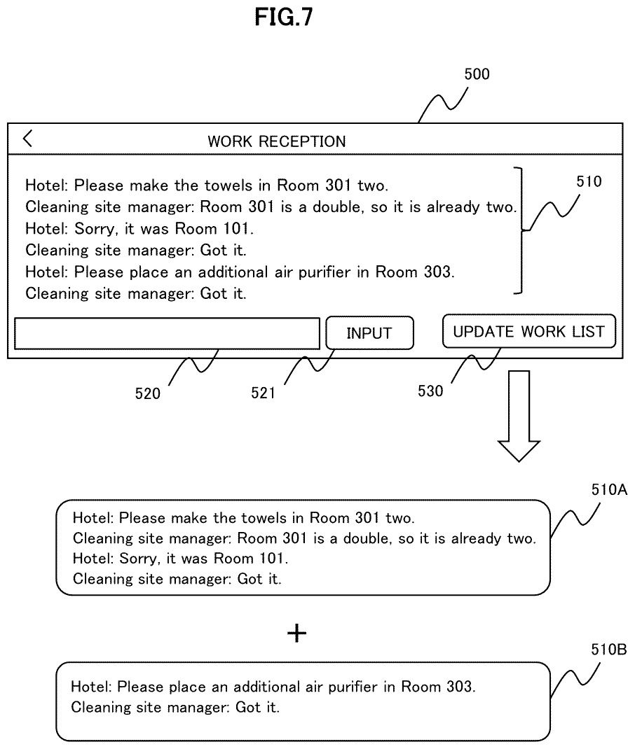

FIG. 7 is a diagram showing an example of the work reception screen. The work reception screen 500 displays the dialogue log conducted in steps S04 and S05 of the work request sequence on the work manager terminal 200. The work reception screen 500 includes a dialogue log display area 510, a speech input field 520, a speech confirmation instruction reception button 521, and a work list update instruction reception button 530. The dialogue log display area 510 displays the dialogue log. The speech input field 520 and speech confirmation instruction reception button 521 are input areas for making speeches on the chat. The work list update instruction reception button 530 is a button that receives the instruction to start the work list update sequence for the dialogue displayed in the dialogue log display area 510.

When input is accepted on the work list update instruction acceptance button 530, in the example of the dialog log shown in this figure, the first half of the dialog 510A with “Hotel: Please make the towels in Room 301 two. Cleaning site manager: Room 301 is a double, so it is already two. Hotel: Sorry, it was Room 101. Cleaning site manager: Got it.” and the second half of the dialog 510B with “Hotel: Please place an additional air purifier in Room 303. Cleaning site manager: Got it.” are separated by the generation unit 324.

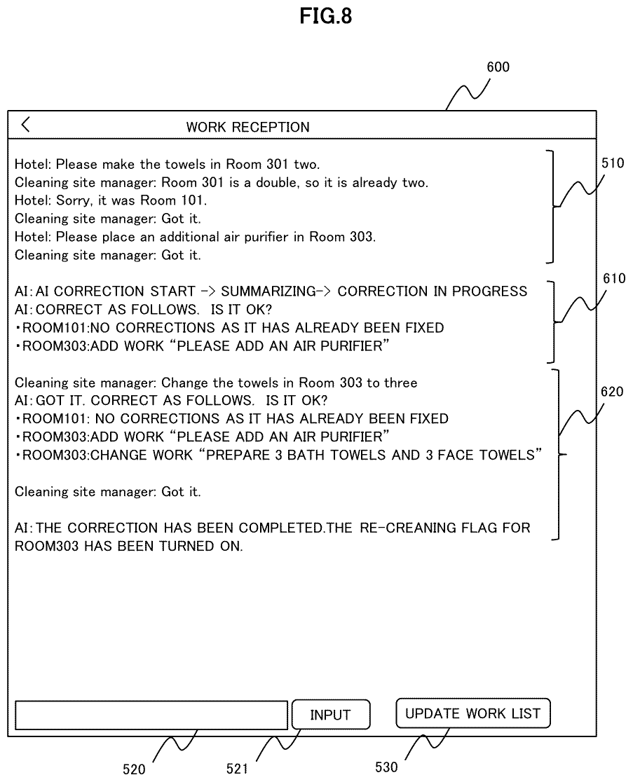

FIG. 8 is a diagram showing an example of the work list update screen. The work list update screen 600 is the screen displayed as a result of the transition from the work reception screen 500, where the confirmation speech 610 of the changes made by the correction application unit 326 is displayed after the dialogue log display area 510, and the correction speech “Cleaning site manager: Change the towels in Room 303 to three” made by the work manager is displayed, and the confirmation speech 620 of the changes made by the correction application unit 326 is further displayed. The confirmation speeches 610 and 620 of the changes are visible only to the work manager and not to the requester.

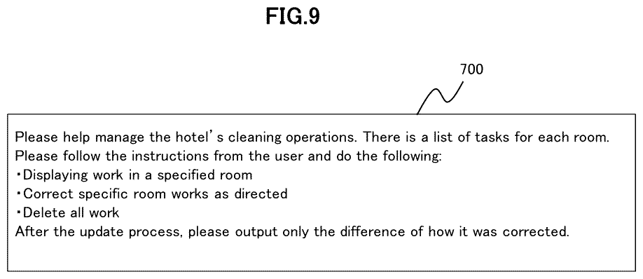

FIG. 9 is a diagram showing an example of the system prompt. The system prompt 700 is an example of the outline of the prompt given to the generative AI of the correction work generation unit 325 to execute the work list update sequence. The system prompt 700 includes instructions such as having a work list for each room, displaying, correcting, and deleting work, and outputting the differences in corrections.

The description of the embodiments of the present invention has been provided above, but the present invention is not limited to the described embodiments and includes various modifications. For example, in the above embodiments, the work list update is executed as a single process, but in cases where additional processing such as re-cleaning is required due to work list updates, additional processing may be performed or not performed depending on the conditions. Specifically, if the work involves increasing the number of towels placed in the room, there is no need to perform re-cleaning, so the re-cleaning flag managed by the work management device 400 is not set. On the other hand, for work such as mattress replacement, the re-cleaning flag may be set. This eliminates missing or unnecessary work during work changes, enabling more appropriate work changes.

The examples of the embodiments described above are detailed to make the present invention easier to understand, and the present invention is not limited to the configurations described here. It is possible to replace parts of the configurations of one example with parts of other examples, add configurations of other examples to the configurations of one example, and add, delete, or replace parts of the configurations of each example with other configurations. The components, functions, processing units, processing means, etc., described above can be realized by hardware, such as by designing an integrated circuit. Moreover, the control lines and information lines in the figures are those considered necessary for explanation and do not necessarily indicate everything. Almost all components can be considered connected to each other.

### REFERENCE SIGNS LIST

1: Work request system
50: Network
100: Requester terminal
120: Processing unit
121: Chat processing unit
130: Display unit
131: Input unit
140: Communication unit
200: Work manager terminal
220: Processing unit
221: Chat processing unit
230: Display unit
231: Input unit
240: Communication unit
300: Work reception device
310: Storage unit
311: Default work list
312: Work list
320: Processing unit
321: Chat provision unit
322: Work management device access unit
323: Transcription unit
324: Instruction text generation unit
325: Correction work generation unit
326: Correction application unit
340: Communication unit
400: Work management device
410: Storage unit
411: Work list
420: Processing unit
421: Inquiry processing unit
422: Correction reception unit
440: Communication unit.

1. A work reception device comprising:
a storage unit that stores work related to a room as a work list for each room number identifying the room;
an instruction text generation unit that summarizes text to generate instruction text related to the work;
a correction work generation unit that reads the instruction text to identify the changes in the work; and
a correction application unit that updates the work list using the changes in the work.

2. The work reception device according to claim 1, wherein the instruction text generation unit has a summary generative AI that has learned to extract change instructions for the work content for each room included in the text.

3. The work reception device according to claim 1, wherein the instruction text generation unit has a summary generative AI that has learned to identify the boundaries of dialogues included in the text and extract change instructions for the work content.

4. The work reception device according to claim 1, wherein the correction work generation unit has a change content specifying AI that has learned to ignore instruction texts when the change content has already been indicated in the work list.

5. The work reception device according to claim 1, wherein the text is a dialogue log made in a text chat or voice chat, and the correction application unit outputs the changes in the work to the text chat or voice chat and updates the work list upon receiving a positive response.

6. The work reception device according to claim 1, wherein the correction work generation unit reads the instruction text for each room to identify the changes in the work.

7. A work reception method using a work reception device, the work reception device comprising a storage unit that stores work related to a room as a work list for each room number identifying the room, and a processing unit that performs:
an instruction text generation step summarizing the text to generate instruction text related to the work;
a correction work generation step that reads the instruction text to identify the changes in the work; and
a correction application step that updates the work list using the changes in the work.

8. A work request system using a work reception device, the work reception device comprising a storage unit that stores work related to a room as a work list for each room number identifying the room, and a processing unit that performs:
an instruction text generation step summarizing the text to generate instruction text related to the work;
a correction work generation step reading the instruction text to identify the changes in the work;
a correction application step updating the work list using the changes in the work.

9. A computer-readable storage medium storing a program which, when executed by a processor, causes the processor to perform the following operations, the computer comprising:
a memory configured to store a work list associated with each room, identified by a room number; and
a processor configured to:
perform an instruction generation step of summarizing text to generate an instruction related to the work task;
perform a correction work generation step of reading the instruction and identifying modifications to the work task; and
perform a correction application step of updating the work task list associated with the room using the identified modifications.
